(19) United States
(12) Patent Application Publication
(10) Pub. No.: US 2004/0160472 A1
(43) Pub. Date: Aug. 19, 2004

(54) Retractable high-speed ink jet print head and maintenance station

(76) Inventors: Najeeb Khalid, Westmount (CA); James Eric Floyd, Montreal (CA)

Correspondence Address: OGILVY RENAULT, 1981 MCGILL COLLEGE AVENUE, SUITE 1600, MONTREAL, QC, H3A2Y3, CA

(21) Appl. No.: 10/366,467

(22) Filed: Feb. 14, 2003

(51) Int. Cl. B41J 2/165

(52) U.S. Cl. 347/22

(57) ABSTRACT

A consolidated page-wide array of jetting modules adapted to move between an operative position in which the face of the array is parallel and proximate to the printing medium and a maintenance position in which it is not. While in the maintenance position, the PWA may be maintained by applying the actions maintenance modules of a maintenance station. Modules include a capping module for purging and priming the jetting modules with solvent, a wiping module for wiping the solvent from the face plates of the jetting modules and a sponging module for removing any excess solvent. The maintenance station may be moved into position while the PWA is in the maintenance position and the maintenance modules may be individually positioned relative to the face of the PWA in order to perform their respective tasks. Sensors to identify the position of the PWA and the maintenance station may permit automated control of the maintenance operation. Neither the PWA nor the printing medium need to be removed in order to maintain the PWA.

### CROSS-REFERENCE TO RELATED APPLICATIONS

This is the first application filed for the present invention.

### MICROFICHE APPENDIX

Not Applicable.

### TECHNICAL FIELD

The invention relates to high-speed ink jet printing apparatuses, and, in particular, to a design for a component of a printing apparatus having a consolidated page-wide array of jetting modules and a mobile maintenance station, and a technique for cleaning a print head.

### BACKGROUND OF THE INVENTION

Much current research and development in the field of high-speed printing and ink-jet printing has revolved around consolidated page-wide arrays (PWA) of jetting modules. Page-wide arrays print continuously as a print medium is passed over the PWA, providing printing rates that are orders of magnitude higher than those possible with scanning ink-jet printers that print over a width of the page, wait until the paper is lowered by a fixed amount, and iterate. Nozzles of jetting modules in PWAs are arranged horizontally so that each nozzle of the PWA is responsible for printing one color of one vertical line on one side of the print medium. Developing a technique and an apparatus for maintaining and cleaning PWAs has proven a difficult task for many reasons.

Cleaning a PWA generally requires bringing different surfaces into contact with the PWA, and for a purging operation to be performed that involves vacuum suction. Consequently a capping station is required for each PWA in the high-speed printer/press in order to provide the required vacuum. This detracts from most imagined design simplification.

There is a PWA cleaning and maintenance technique currently known for cleaning PWAs and surrounding PWA casements. The cleaning technique involves insertion of a cleaning surface into a paper feed system (such as that of U.S. Pat. No. 5,589,865 entitled INKJET PAGE-WIDE-ARRAY PRINT HEAD CLEANING METHOD AND APPARATUS, which issued to Robert R. Beeson on Dec. 31, 1996). While at first glance this approach purports to avoid complications to the design of the high-speed printer/press that are otherwise required to perform cleaning operations, the cleaning surface passed through the web can only provide a small subset of the numerous actions required for maintaining and cleaning most PWAs.

Moreover a further disadvantage of Beeson, in the context of many high-speed printers/presses, is that a roll of the printing medium in the paper feed system of the high-speed printer/press needs to be removed in order to insert the cleaning surface, and reinserted with correct alignment, after the cleaning is performed. Removing the paper from the web is time consuming and printing apparatus down time constitutes a loss that cannot be recouped by printer/press operators. Given the frequency with which cleaning and purging operations need to be applied, permitting the maintenance of a PWA print head without removing paper from the web, is desirable.

While scanning (non-PWA) print head cleaning/maintenance stations are well known in the art, the differences between the PWA and scanning printers do not facilitate the mere adoption of known techniques and apparatuses from the scanning printer arts. Whereas scanning print heads generally move to one side of the scan area for maintenance, the width of consolidated PWAs, and their stationary nature does not lend itself to an analogous solution. Nonetheless substantially the same maintenance operations need to be performed on the scanning print heads. Cleaning modules known in the scanning printer arts frequently involve a capping element for sealing and permitting a vacuum to be applied to the print heads and a wiper element for wiping a surface of the print head. The capping elements are also applied when the print heads are not in use, so that ink does not dry up inside and around the print head. The capping elements are also known to be used to apply a vacuum and to prevent ink leakage when priming and purging the print heads. An example of such a maintenance station (called a servicing module) is described in U.S. Pat. No. 6,042,216 entitled REPLACEABLE PRINTHEAD SERVICING MODULE WITH MULTIPLE FUNCTIONS (WIPE/CAP/SPIT/PRIME), which issued to Garcia et al. on Mar. 28, 2000.

As is well known in the art, a fixed distance (typically of about one millimeter) must be maintained between the PWA and the print medium passing through the paper feed system, in order to ensure that the ink jetted from the nozzles of the PWA lands as expected on the paper. Consequently, there is no room for a cleaning station to meet the PWA without disassembling the printing web in today's consolidated page-wide array printing apparatuses.

It is therefore desirable to design the print head and a maintenance station to function with it without obstructing the print web.

There are a number of mobile maintenance stations known in the art. For example, U.S. Pat. No. 6,142,622 entitled INK JET PRINTER AND METHOD, which issued to Blanchard et al. on Nov. 7, 2000, describes pivoting print heads, principally for enabling the insertion of a label web into a printer. While in such an inactive, “stored”, position the print heads can be manually wiped clean. There is no cleaning module in the printing unit disclosed in U.S. Pat. No. 6,142,622. Although the prior art teaches methods for accessing print heads for manual cleaning, the numerous drawbacks of manual cleaning, will be readily appreciated.

There therefore remains a need for a method and component of a printing apparatus designed for maintenance and cleaning of a consolidated page-wide array of jetting modules, without obstructing a printing area of the printing apparatus.

### SUMMARY OF THE INVENTION

Therefore, it is an object of the invention to provide a component of a high-speed ink-jet page-wide array (PWA) printing apparatus that provides for the maintenance of a PWA without obstructing a printing area of the printing apparatus.

It is a further object of the invention to provide a method for providing maintenance operations for a consolidated PWA of jetting modules in a high-speed printing apparatus using a cooperating maintenance station.

Accordingly a PWA is provided that is movable between a first position for printing operations, and a second position for cleaning operations. The PWA moves with respect to the casing, as a part of an automated maintenance procedure.

The PWA may be moved from its operative position parallel to the plane of a printing area and proximate thereto, to a maintenance position, whether by retracting the PWA transversely away from the plane of the page or by rotation of the orientation of the PWA with respect thereto. The maintenance station contains a capping module, wiping module and sponging module is adapted to engage the face of the PWA while the PWA is in the maintenance position, without impacting the printing area or requiring the material to be printed to be removed. Once the maintenance station is in place, the capping module moves into suction contact with the face of the PWA and the maintenance station purges the jetting modules, in a manner known in the art. When complete, the capping module releases sealed contact with the PWA. The wiping module removes excess solvent from the surface of the jetting modules in the face of the PWA in a vertical motion. Thereafter, the sponging module wicks away any remaining solvent from the face of the PWA. The maintenance station may be removed and the PWA may be returned to the operative position for printing.

The position of the PWA may be readily determined, for example by conductive contact with a wire closing a circuit.

### BRIEF DESCRIPTION OF THE DRAWINGS

Further features and advantages of the present invention will become apparent from the following detailed description, taken in combination with the appended drawings, in which:

FIG. 1 schematically illustrates a prior art jetting module;

FIG. 2 schematically illustrates a consolidated page-wide array of jetting modules;

FIGS. 3a-c schematically illustrate three principal stages in an automated procedure, in accordance with an embodiment of the invention;

FIG. 4 schematically illustrates three maintenance modules of a maintenance station for meeting the consolidated page-wide array of FIG. 2, in accordance with an embodiment of the invention;

FIG. 5 schematically illustrates an embodiment of a maintenance station for the PWA of FIG. 2 having the maintenance module of FIG. 4;

FIG. 6 schematically illustrates a component of a high-speed printing apparatus including the maintenance station of FIG. 5;

FIG. 7 schematically illustrates an alternative embodiment of a design for a component of a high-speed printing apparatus;

FIG. 8 schematically illustrates an embodiment of a control system for use in accordance with the present invention;

FIGS. 9a, b, c schematically illustrate 3 principal stages in the automated procedure according to an alternative embodiment of the invention; and

FIGS. 10a, b schematically illustrate 2 principal stages in the automated procedure according to another embodiment of the invention.

It should be noted that throughout the appended drawings, like features are identified by like reference numerals.

### DETAILED DESCRIPTION OF THE PREFERRED EMBODIMENT

Overview

FIG. 1 schematically illustrates a jetting module 11 commonly known in the art. For example a 180 dots per inch (dpi) jetting module of substantially this format is currently commercially available. Those skilled in the art will recognize that the jetting module 11 is often referred to as a “print head”. The term is used herein to denote a module of a printer/press that includes an array of the jetting modules along with the maintenance station and casing. The print head is a removable module that prints one color of ink on one side of a print medium. The print head is self-cleaning and is serviceable by trained personnel. For simplicity and clarity of illustration, the jetting module 11 illustrated has only 32 nozzles 12 that are used to project ink perpendicular to a face plate 14 of the jetting module 11. Those having ordinary skill in this art will recognize that a greater or lesser number of nozzles 12 may be used. Preferably, the nozzles 12 are disposed across the face plate 14 in a saw-tooth pattern.

As is well known in the art, the jetting module 11 also has a circuit board for processing print data, and subsequently directing the firing of respective nozzles 12. The nozzles 12 are connected to an ink supply system that interconnects the jetting module 11 with an ink source of the printing apparatus. Power is supplied to the jetting module.

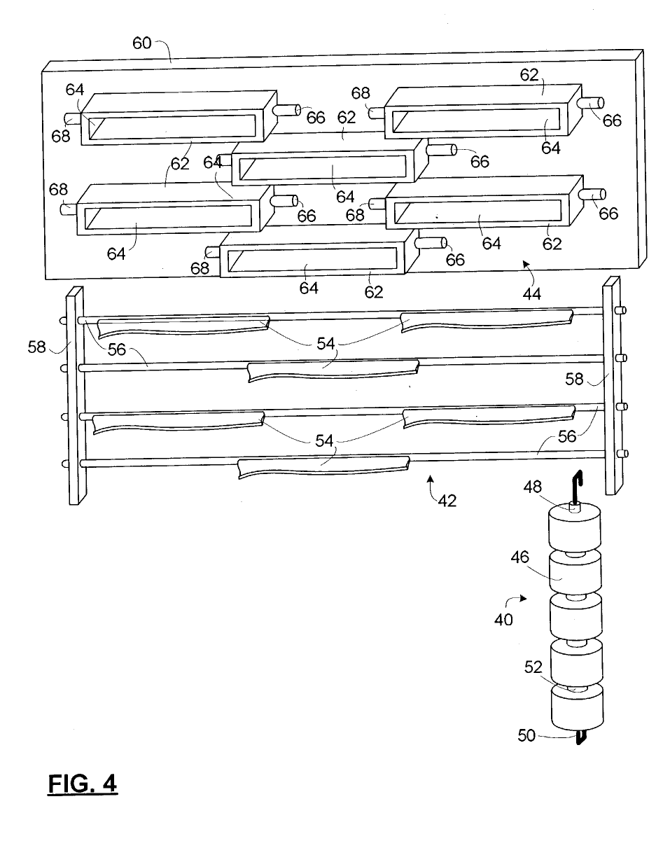

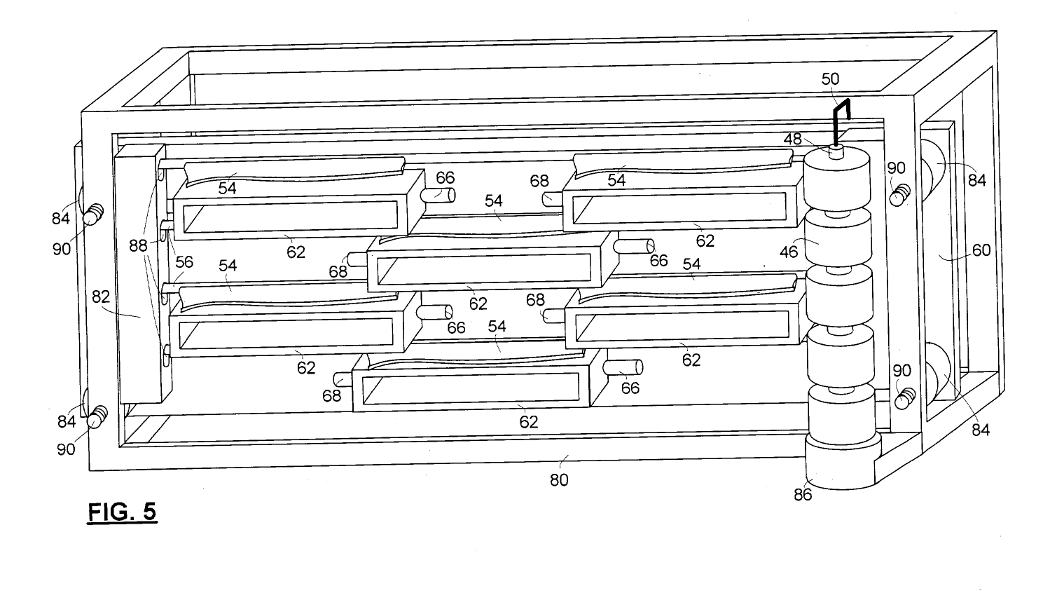

The nozzles 12 of the jetting module 11 form respective orifices in the face plate 14, and these need to be periodically cleaned of potential obstructions in the form of dried ink or other contaminants. A protruding frame sometimes encloses the face plate 14 of the jetting modules, which imposes some limitations on the design of wipers, as will be further explained below, particularly with reference to FIG. 4.

As is known in the art, priming, purging and capping a jetting module are related operations requiring a sealed contact with a cap. The cap is sealed around nozzles of the jetting module, and a vacuum removes air, ink, and any other contaminants, when purging or priming. Purging is the most commonly used of these procedures, and is used for regular preventative maintenance of the jetting modules. A capping operation is required when the printer is going to be idle for a considerable length of time. Priming, as is also known in the art, is used to remove air from ink supply channels when the jetting module is first installed.

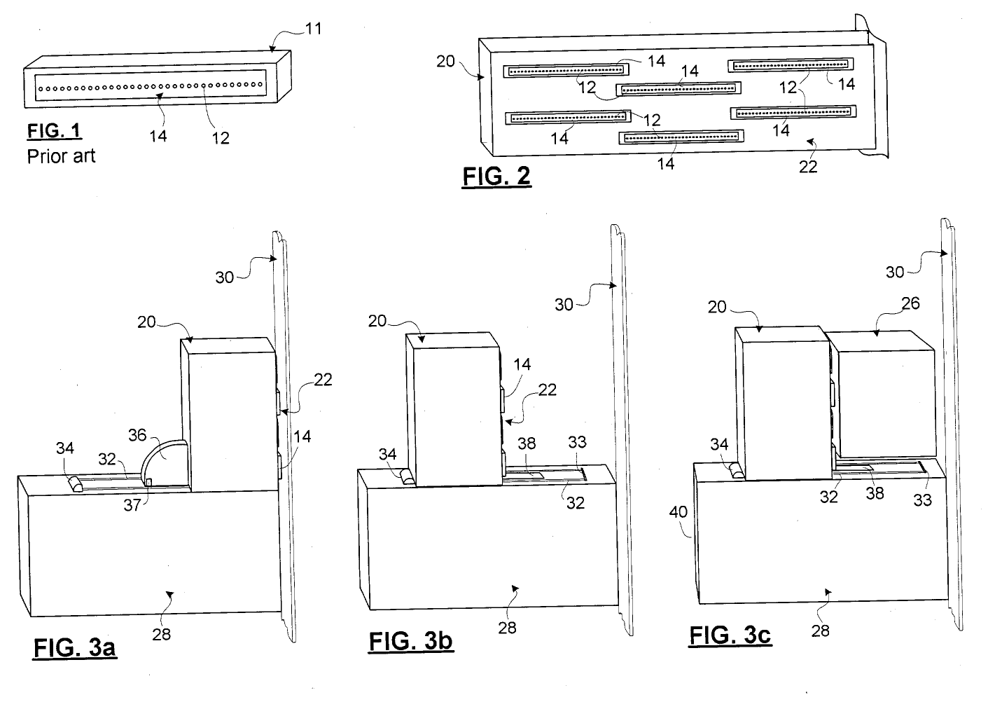

FIG. 2 schematically illustrates a consolidated page-wide array (PWA) 20 of jetting modules 11 for use in the present invention. As earlier discussed, a casement sometimes extends around the jetting modules 11 beside the nozzles, preventing jetting modules 11 from being abutted against one another in the PWA 20. The gaps that remain would leave unacceptable bands of blank space on printed material. Consequently the jetting modules 11 are staggered with overlap that compensates for the width of the casement, permitting a gap-free alignment of the jetting modules 11. Effectively the horizontal projections of all of the nozzle orifices are evenly spaced apart. As is further illustrated, each of the jetting modules 11 is paired with a mate, which is off-set by a half of a distance between the nozzles of the jetting modules 11, so that the cumulative output of the pairs is twice as many nozzles, evenly spaced. Consequently a resolution of 360 dpi is obtained from a pair of 180 dpi jetting modules. As will be clear to those of skill in the art, substantially any arrangement of jetting modules in a PWA is amenable to the present invention to achieve different multiples of print resolution.

A front plate 22 of the PWA 20 acts as a support member to consolidate the plurality of jetting modules 11, holding them in rigid alignment. The number of the jetting modules 11 in a PWA 20 may depend on design options and the width of the area to be printed. The protruding frame surrounding face plates 14 of respective jetting modules 11 of the PWA 20 meet flush with the front plate 22.

FIGS. 3a-c schematically illustrate three principal stages in a method for wiping and priming, purging or capping PWA 20, in accordance with the present invention. Those of skill in the art will immediately recognize that the embodiment illustrated is simplified in a number of respects. The forms of the PWA 20 and a maintenance station 26 are not illustrated in detail, and signaling cables, ink supply tubing, power supply, vacuum equipment, as well as control system sensors and links, have all been omitted in these three illustrations for clarity.

As illustrated in FIG. 3a, a PWA 20 is installed in a printing apparatus, resting on a casing 28, in an operative position. The front plate 22 that houses the nozzles 12, squarely meets a surface of a sheet of print medium in a paper web 30 of a printing apparatus. The print medium is maintained at a fixed distance from the front plate 22 by applying tension to the print medium using rollers and paper feed controls that comprise the paper web 30, in a manner known in the art. As will be apparent to those of skill in the art, the PWA 20 will equally be supported by the sides and top so that the printing apparatus can be moved and otherwise subjected to minor adjustment, without PWAs 20 falling out of alignment. For the purposes of illustration, however, only a bottom component of the casing 28 is illustrated. This also serves to stabilize the PWA 20. As will be recognized by those of skill in the art, the motions of the PWA 20 and the maintenance station 26 and their positions at all times should be highly constrained in order to ensure accurate positioning of the jetting modules face plates 14 with respect to the paper web 30. At the same time, the motions of the PWA 20 and the maintenance station 26 must be unobstructed and they must align correctly when they are in a maintenance position.

The casing 28 maintains the PWA 20 in the operative position illustrated in FIG. 3a, supports and guides the PWA 20 during transit from the operative position to a maintenance position (illustrated in FIG. 3b as being retracted in a direction transverse to the plane of the paper web 30), and maintains the PWA 20 in the maintenance position throughout the maintenance procedures described below (illustrated in FIG. 3c) . The illustrated casing 28 includes a set of rails 32 for guiding the motion of the PWA 20 between the two positions, although any number of other mechanisms for controlling motion known in the art may be used.

A top end boss 33 (visible in FIG. 3b) of the rails prevents the PWA 20 from advancing transversely too close to the paper web 30, providing support for the PWA while in the operative position. The top end boss 33 may be one of a number of features of the casing 28 and the PWA 20 that jointly provide the stable and sound positioning of the PWA 20 when in the operative position, using any support and motion isolation technique known in the art. Further, a snubbing feature 34 of the casing 28 limits the distance that the PWA 20 can be retracted. The top end boss 33 and the snubbing feature 34 may cooperate with or be replaced by other features that stabilize and support the PWA 20 in the maintenance position. Such features may cooperate with a drive system (not illustrated) that provides the motive force for propelling the PWA 20 between the positions.

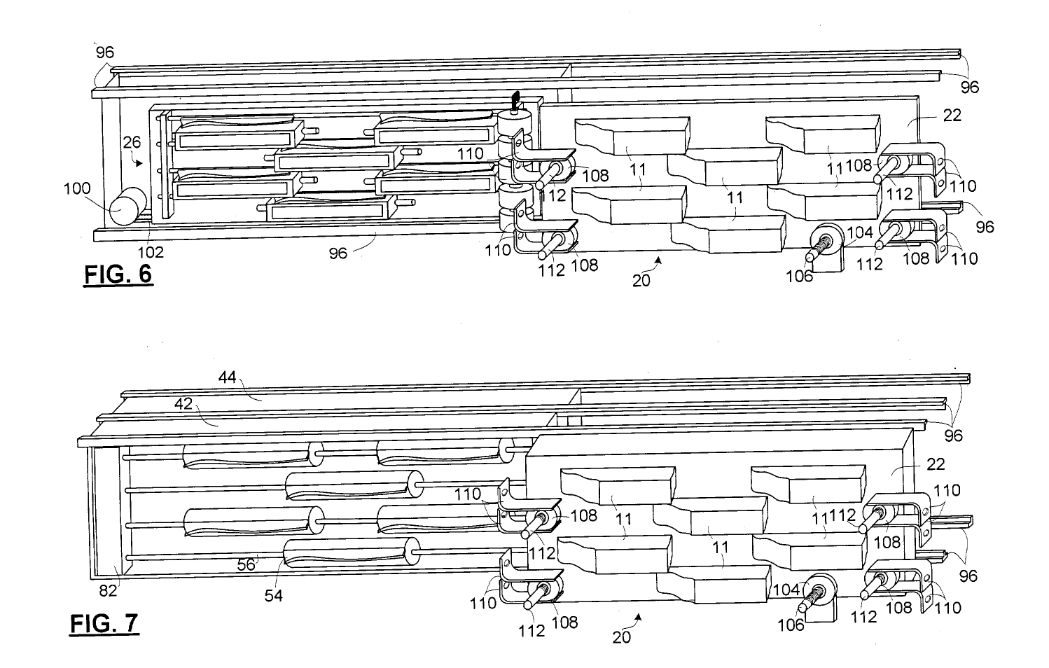

A mechanical force is supplied to move the PWA 20 from the operative position to the retracted position, and back again. Preferably the mechanical force is supplied by a DC motor via an actuator, known in the art. Many such actuators are known, and rail systems, rack and pinion systems, belt-drive systems, and piston systems could all be used to provide this force. Moreover, the system can be controlled by a stepper motor, or a set of sensors, for example. An embodiment of the actuators is further described below with reference to FIGS. 5 and 6.

The motion of the PWA 20 is controlled in part by the physical support and contact with features of the casing and the PWA 20, and, in part, by the actuator and drive system. Together the features and the drive system co-operate to ensure that the PWA 20 is captively held in the predefined positions, and is well supported in its motion there between.

A latch 36 (shown in exemplary fashion in FIG. 3a) provides captive support to the PWA 20 when the PWA 20 is in the operative position. Preferably the latch 36 is biased towards a locking position illustrated in FIG. 3a, so that the latch 36 supplies a steady force to maintain the PWA 20 in the operative position. When a force of retraction is applied to the PWA 20, however, the bias is overcome, and the latch 36 is pushed down into an opening in the casing 28 (as illustrated in FIG. 3b, wherein only an edge surface 38 of the latch 36 can be seen). The PWA 20 depresses the latch 36 unless the PWA 20 is in the operative position, and consequently a simple print-ready sensor can be devised to detect when the PWA 20 is in the operative position. Such methods are well known in the art, and can include a simple circuit closed or opened by contact with conductive edges 37 of the latch 36, for example.

In operation, the PWA 20 is moved from the operative position to the retracted position by retraction in a direction transverse to the plane of the paper web 30. Consequently a gap is formed between the paper web 30 and the PWA 20, above the casing 28. The gap is of sufficient dimension to permit the maintenance station 26 to be inserted into position in relation to the front plate 22. As illustrated in FIG. 3c, the maintenance station 26 is in place in the gap.

As will be evident to those of skill in the art, the insertion of the maintenance station 26 into place is a highly constrained motion. Systems of highly constrained motion are well known in the art and choices that lead to particular embodiments are largely design electives that match particular layouts of the printing apparatuses for a least cost. It is assumed that these are familiar to one who wishes to practice the present invention.

Analogously with the motion of the PWA 20, the insertion of the maintenance station 26 is controlled so that it is captively held in an idle position and in a working position, wherein it abuts the front plate 22 of the PWA 20. Similarly, the maintenance station 26 is guided in its motion between the two positions, by features of the maintenance station 26, features of maintenance station supports (not illustrated), and a drive system.

At this point, as described below and with the assistance of modules in the maintenance station 26, maintenance operations may be performed. The face plates 14 of the jetting modules 11 may be capped, wiped, or sponged. There may be a spittoon for receiving ink ejected from the nozzles, or a sponge for wicking ink and other fluids away from the face plates 14 of the jetting modules 11.

Exemplary modules for the maintenance station 26 are schematically illustrated in FIG. 4. The modules are designed to perform respective tasks. There are three maintenance modules in the illustrated embodiment: a capping module 44, a wiping module 42 and a sponging module 40.

The capping module 44 is used for priming, purging, or capping the jetting modules 11 of the PWA 20. The capping plate 60 consists of a plurality of rubberized, extruding, caps 62 that are aligned to meet with corresponding jetting modules 11 on the front plate 22 the PWA 20. Preferably the caps 54 are individually spring-loaded to improve pressure contact between the caps 54 and respective face plates 14. Each of the caps 62 forms a chamber 64 permitting fluid communication between two tubes: an air intake tube 66, and a vacuum/exhaust tube 68. The chambers 64 are adapted to withstand a negative, pressure differential with respect to the ambient air when rectangular openings of the caps 62 are sealed.

All of the air intake tubes 66 on a capping plate 60 preferably terminate at a common air intake chamber that has a valve for collectively controlling the air intake tubes 66. As is well known in the art, a solenoid valve can be used to open and close the common air intake chamber, as it provides for relatively simple and inexpensive actuation. Likewise the vacuum/exhaust tubes 68 are preferably in fluid connection with a common chamber, which is in fluid connection with a vacuum.

In operation, the PWA 20 is moved into a capping position (which is a small distance forward of the maintenance position), and a capping plate 60 of the maintenance station 26 is moved closer to the PWA 20 in order to form a pressure contact with the jetting modules 11. The pressure contact is maintained to provide an imperfect seal around the nozzle orifices. The imperfect seal is effected by supplying a mechanical force to push caps and face plates 14 together. This mechanical force may be supplied by the same motor that supplies the mechanical force to retract the PWA 20, by the motor that causes the sliding motion of the maintenance station, by a third motor, or any two of the above, for example. In current embodiments the pressure contact force is supplied jointly by the DC motor that retracts and protracts the PWA 20, and by a maintenance module motor that pushes the caps 54 of the capping plate 60 into contact with the face plates 14.

The imperfect seal is sufficient to allow depressurization of the cap when a vacuum is applied to remove fluid content of the cap. The seal need only be tighter than the fluid resistance that keeps the ink from flowing through the nozzles 12.

When suction is applied through the vacuum/exhaust tube 68, the ink flows through the nozzles 12 if the air intake tube 66 is closed. If the air intake tube 66 is open, and the suction is applied, air flows through the intake tube 66, across the face plate 14 of the jetting module 11, and into the vacuum/exhaust tube 68.

However, once the vacuum suction is removed, the imperfection of the seal will result in a slow leak of ambient air outside the cap entering into the cap. Thus, if the suction is stopped and the air intake tube 66 is closed, the residual vacuum is slowly filled by ambient air entering the chamber 64 via the imperfect seal. The imperfect seal is used to provide this repressurization. Otherwise, opening the air intake tube 66 might cause a turbulent flow of air that would impair the formation of the meniscuses on the nozzle orifices.

The caps 62 may be used for capping, purging and priming the jetting modules 11. The purging operation is used regularly to remove any ink that may have splattered back from the page during printing, or any other contaminants that might soil the jetting module 11 and surrounding face plate 22. In particular, it is known that splattered ink and ink that condenses from a mist may pool on the jetting module face plate 14. A sufficient build up of ink will fall under the force of gravity, and potentially splatter on the printing medium. Furthermore dried ink near the nozzle orifices of a jetting module 11 may form an obstruction to the nozzle 12 that will divert or block a jet emitted there from, further degrading printing quality.

As is known in the art, ink is often used as the solvent for cleaning jetting modules and print heads. The capping module 44 removes the ink and any dissolved materials. Once a predefined duration (usually in the order of a minute) has expired, the chamber is slowly repressurized, so as not to damage the delicate nozzles 12.

If a jetting module 11 is newly installed on a printing apparatus, its nozzles are not moist and there may be pockets of air or other contaminants in the nozzles, or elsewhere in the ink supply. Consequently the nozzles 12 must be purged for a long time to ensure that subsequent ink flow is regular. Purging or priming involves drawing ink (and any air or other contaminants) through the nozzles 12.

The only difference between priming and purging is a matter of degree. In either case, once the chambers 64 are sealed, suction is applied. If suction is applied for about a minute, the nozzles 12 are said to be primed. If the suction is provided for much longer, (in excess of 5 minutes) the nozzles 12 are said to be primed. Nozzles 12 are typically primed when the PWA 20 is connected to ink supply, whereas, they are purged with a predefined regularity, such as every 45 minutes, or twice per roll of print medium.

As the purging or priming draws air before the ink, the ink that is collected in the chamber 64 of the cap 62 advantageously pools in the cap where it serves as a solvent for absorbing contaminants and dried ink left on the face plate 14 of the jetting module 11. Once the requisite length of time has passed, the suction is stopped. The pressure difference between the chamber 64 and atmosphere slowly equilibrates as air leaks across the imperfect seal. The air intake tube 66 is opened and the vacuum is applied again to remove ink remaining in the chamber 64. The face plates 14 need to be wiped after this process, as they will now be coated with fresh ink.

Capping a jetting module 11 may also be required when the module is not going to be used for an extended length of time. For example, if only black and white printing is required, the cyan, magenta and yellow ink jetting modules are capped to prevent the ink from drying up on the face plates 14 or in the nozzle orifices. The caps 54 are held in pressure contact with the face plates 14 of the jetting modules 11. Capping suspends activity and retains the pressure in the cavity until the jetting module 11 is to be used again.

The wiping module 42 is used to carefully squeegee ink from recently purged or primed face plates 14 of respective jetting modules 11 of the PWA 20. The wiping module 42 consists of a plurality of wiper blades 54, each corresponding to a jetting module 11 in the PWA 20. Each of the wiper blades 54 is rotateable about a substantially horizontal axle rod 56, to which it is affixed. The four axle rods 56 illustrated are supported by a frame structure 58. The frame structure 58 is moveable in a circuitous path by a rotary drive system (not illustrated). The frame structure 58 and the circuitous path about which it is moveable is designed to ensure that the axle rods 56 will move in a similar path in unison and make proper contact with the face plates 14 while avoiding obstacles. Preferably the rotary drive system jointly powers both revolution and the rotation to ensure phase alignment between the revolution and the rotation. Various means for driving the rotation and revolution are commonly known in the art, and consequently are not illustrated. The shape of the circuit will depend on the size of the wiper blades 54, the distance between the axle rods 56 and the face plates 14 of the jetting modules 11, and any obstructions that the wiper blades 54 may need to avoid.

As was previously discussed, a protruding frame encloses the nozzles 12 in certain jetting modules 11. While this protrusion protects the sensitive nozzles 11 and the meniscus boundaries from contacting a printing medium fed through the printing apparatus, etc., the edges formed by the frame are far too hard and sharp to contact the supple wiper blade 54 without damaging them. The dimensions of the wiper blades 54, and the range of motion through which the wiper blades 54 are to pass, are therefore preferably selected to maximize the surface surrounding the nozzle orifices that are to be wiped without contacting the edges of the frame or any other components of the maintenance station 26.

The primary purpose of wiping is to remove any dried or drying ink from the surface of the face plate 14 near the nozzle orifices along with the solvent. As was previously discussed, this ensures proper operation of the nozzles 12 because obstructions to them may cause printing flaws. Further, dried ink inside the nozzles 12 cannot be cleaned on location (if at all), and so preventative maintenance is called for. Once the face plates 14 of the jetting modules 11 have been soaked in a solvent, as by a priming or purging operation involving the capping module 44, the wiper blades 54 of wiping module 42 are used to wipe off any contaminant, ink, or solvent that remains on the respective face plates 14.

Preferably, a top-down wiping motion is used. As the nozzles 12 of the jetting modules 11 are substantially horizontally laid out, such a wiping motion prevents the wiper blade 54 from pushing the ink, contaminant or solvent from one nozzle into an adjacent nozzle 12, as may happen if a side-to-side motion were used for the wiping.

It is sometimes preferable to repeat a purging after wiping. This repeated purging might be a micro purge that lasts a much shorter length of time (a few seconds) than the purge/prime. Additionally, the nozzles 12 may be required to spit (fire) a few times into the cap 62 to avoid any defect in the first firings of the nozzles 12 after the purging/priming.

Some of the ink from the priming or purging operation will remain on the blade wipers 54 but the rest will be channeled away from the nozzle orifices, to be cleaned by the sponging module 40, described below.

The sponging module 40 is designed to operate when the maintenance station 26 is in position, and the PWA 20 is in the maintenance position, in this embodiment, the position of maximum retraction (from the paper web 30).

The sponging module 40 contains an absorbent material 46 to wick ink or any other solvent applied to, or gathered on the surface of the front plate 22 of the PWA 20, particularly after purging or priming and wiping operations have been completed. Because a solvent is usually applied to the front plate 22 during cleaning (the solvent usually being fresh ink), preventing drying ink from clotting on the surface requires leaving a greater residue of wet ink on the front plate 22. While wiping preferably serves to channel the solvent away from the nozzle orifices, it should then be mopped up.

The absorbent material 46 is affixed to a roller 48 that rotates about an axle 50. The roller 48 preferably includes a gripping part that is engaged by a rotary drive means to spin the roller 48 and the attached absorbent material 46. The rotation of the absorbent material provides fresh parts of the absorbent material to new parts of the front plate 22.

Cylindrical recesses 52 in the absorbent material 46 are aligned with nozzles 12 of the jetting modules 11 so that ink absorbed from the front plate 22 is not deposited on the nozzle orifices, and so that a meniscus that marks a boundary between the ink in the orifices and the ambient air does not encounter the absorbent material 46. Preferably the area sponged by the absorbent material 46 overlaps with a portion of the face plate 14 of the jetting modules 11 so that the channeled solvent is mopped up.

As the sponging operation is required only at the very end of maintenance or cleaning operations, the motion of the absorbent material over the front plate 22 may be performed while the maintenance station 26 is being moved back to its storage position.

In some embodiments of the present invention, including those in which the sponging position is the retracted position, the sponging apparatus further takes on a secondary role. When the PWA 20 is first moved into the maintenance position, and the maintenance station 26 first moves into place, the absorbent material 46 will pass across the front plate 22. This initial sponging will not absorb very much fluid from the front plate 22, but will, advantageously, serve to encourage condensation of droplets of ink that are suspended in the air.

After the maintenance operations have been completed, some solvent will remain on the blade wipers 54. Accordingly a means for cleaning the ink from the blade wipers 54, and from the absorbent material 46 is required after completion of the maintenance operations. Preferably the ink is transferred from the blade wipers 54 and absorbent material 46 onto felt pads, in a manner known in the art, when the maintenance station has returned to its idle position. This can efficiently be performed with the operations of the same spinning and rotating drive systems that were used to wick and wipe the front plate 22, respectively. Alternatively, a wiping surface for the blade wipers 54 and absorbent material 46 can be integrated with their respective modules so that the blade wipers 54 and absorbent material 46 can be cleaned while cleaning their respective surfaces.

The modules illustrated in FIG. 4 are held together with a frame 80 as shown in FIG. 5. Three drive systems are included in the maintenance station 26: a capping drive system 84, a wiping drive system 82 and a sponging drive system 86.

The capping drive system comprises four direct current (DC) motors 84a, b, c, d. The DC motors 84a, b, c, d are fixed to the capping plate 60 and adapted to rotate respective bolts 90a, b, c, d rigidly coupled to an axle of the respective DC motor. The bolts 90a, b, c, d project through the plane of the capping plate 60, and are threaded in respective, reciprocally-threaded holes in the frame 80, so as to impart a force on the frame 80 when rotated, causing the capping plate 60 to move in a direction normal to the plane of the capping plate 60. The four sets of DC motors and bolts work in unison so that there is no potentially damaging shearing force applied to capping plate 60 or the frame 80.

The wiping drive system 82 comprises a low-friction guiding and supporting end 82a and a driver end 82b, which differs from the supporting end 82a in that it is connected to a direct current (DC) motor and controller. The supporting and driver ends 82a, b support the end of the structure 58 and the driver end 82b causes, by a low-friction guidance system (not shown), the structure to be moved in a circuitous path in a plane normal to the axis of the axle rods 56. Thus, the axle rods 56 move along the same path in unison and cause the supported blades to do so as well. The path followed by the structure 58 and the axle rods 56 is such that the wiper blades 54 come into contact with the face plate 14 during a portion of the circuit and move vertically relative to the face place 14 while maintaining substantially even pressure during this interval. At the same time, the structure 58 causes each axle rod 56 to rotate about its axis.

The sponging drive system 86 is adapted to spin the roller 48 and with it, the absorbent material 46. If the sponging happens only when the maintenance station 26 is sliding between the idle and working positions, the axis of the roller may be fixed with respect to the maintenance station 26, and the motive force for the spinning of the roller 48 may be shunted from a drive system that causes the sliding of the maintenance station 26.

FIG. 6 schematically illustrates a component of a printing apparatus. The component comprises a PWA 20 of jetting modules 11 that are consolidated by a rigid front plate 22, and a maintenance station 26. The illustrated embodiment shows the PWA 20 (reverse view) in the retracted position, and the maintenance station 26 in the idle position. The frame 80, and the drive systems of the maintenance station 26 illustrated in FIG. 5, are not shown in FIG. 6. The frame 80 is designed to be rolled across top and bottom guide rails 96 that enable the maintenance station 26 to be slid between the idle and working positions. The illustrated embodiment of FIG. 6 schematically illustrates drive systems for supplying the motive forces to retract and protract the PWA 20, and to slide the maintenance station 26. The drive systems comprise matching features of the surfaces of the maintenance station 26/PWA 20 and support/casing. The rails 96, that are affixed to the support of the maintenance station 26, while low-friction guides 98 ensure a uniform retraction/protraction of the PWA 20, to minimize destructive effects of shearing forces on the PWA 20.

The drive systems further comprise DC motors and actuators. A belt drive system 100 and DC motor 102 communicate a motive force to cause the maintenance station 26 to slide between the idle and working positions, in a manner well known in the mechanical arts. Many other drive systems are equally known in the mechanical arts for achieving the desired result, and may be preferred in different printing apparatuses. The retraction/protraction of the PWA 20 is driven by a DC motor 104 rigidly secured to the casing. The DC motor 104 is adapted to rotate a threaded collar (not illustrated). The threaded collar of the DC motor is threadedly connected to a bolt 106 that is secured to the front plate 20. By rotating the threaded collar, the bolt is propelled in a direction orthogonal to the direction of rotation. The DC motor 106 is normal to the front plate 22, so that the motion of the bolt, which is rigidly connected to the PWA 20, consequently induces the retraction or advance of the PWA 20. Low-friction guides 108 also connected to the casing (with pairs of brackets 110), prevent shearing forces caused by the off-center position of the bolt 106, from causing any misalignment of the PWA 20. Each low-friction guide 108 comprises a pin 112 inserted into a cylindrical guide held by sets of lubricated bearings that permit a smooth guiding surface through which the pin 112 passes, during retraction or protraction of the PWA 20.

The height of the maintenance station 26 is greater than that of the PWA 20, so that the path between the retracted and operative positions of the PWA 20 is not obstructed by the guide rails 96 that, as illustrated, overlap the length of the maintenance station 26.

FIG. 7 schematically illustrates an alternative implementation of a PWA 20 and maintenance station 26 for a printing apparatus, in accordance with the objects of the invention. As will be readily apparent to those of skill in the art, the view is again highly selective because all of the electronic cabling, the power supply system, the ink supply system, maintenance control system, etc. are not illustrated. FIG. 7 also illustrates the rear view of the PWA 20 that is punctuated by protruding back ends of the modules 11. The PWA 20 is again mounted to walls (not illustrated) of the printing apparatus via the low friction supports 108 and the DC motor 104 and bolt 106. Additional guides, or features of the surface of the casing and PWA 20 may be used to ensure that the PWA 20 is correctly returned to the operative position as exactly as needed to ensure alignment with any other PWAs in the printing apparatus, and a paper web 30 in the printing apparatus.

The maintenance station 26 illustrated in FIG. 7 differs from that of FIG. 6 in relation to one aspect. Two maintenance modules of the maintenance station 26 are separately slidable in accordance with the embodiment illustrated in FIG. 7. The two separately-sliding maintenance modules illustrated are a wiper module, similar in operation to the wiper module 42, and the capping module 44 (which is not visible behind the wiper module). The two maintenance modules are independently slidable along respective sets of rails 96, so that, provided the position of the PWA 20 is controlled, either of the maintenance modules can be slid into place operatively facing the PWA 20. The PWA 26 and the remainder of the management station 26 illustrated in FIG. 7, are unchanged with respect to FIG. 6, and their description will not be repeated here.

A control system can be embodied by a set of emergency cut-off switches (that will be included in most embodiments of the present invention to provide safe operations in the event of a sensor malfunction). Emergency cut-off switches may, for example, cut power to a drive motor prior to collision with another object.

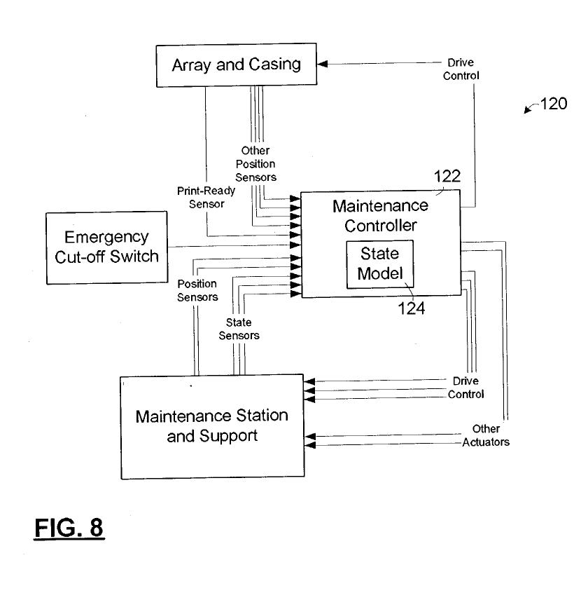

There are numerous possible embodiments of a control system for the components of the printing apparatus illustrated in FIGS. 6 and 7. A high-level schematic view of such a control system is illustrated in FIG. 8. The control system 120 is used for controlling actuators, including drive controllers, in response to programmed and requested maintenance procedures, a state model of a condition of a component of the printing apparatus, and sensor feedback from a sensor. In accordance with the purview of the control system 120, a maintenance controller 122 of the control system 120 maintains the state model 124 of the component. The maintenance controller 122 may be provided on any computing device, including a special purpose computer, in accordance with the present invention. Preferably a computer that distributes print data to the jetting modules 11, and therefore controls the firing of the nozzles 12, executes the maintenance controller operations. This is preferable because it prevents conflicting commands from being issued. Furthermore it is effective to provide the maintenance controller 122 with the capacity to effect spitting of the nozzles 12 on demand.

The actuators that may be controlled include the DC motors 104, 100, the wiping, capping, and sponging drive systems 82, 84, and 86, respectively, the air intake shut-off valve, and the vacuum that supplies the suction. Other actuators may be controlled: emergency cut-off switches may be activated or de-activated when associated elements are not moving, for example. The maintenance controller 122 is adapted to issue control signaling to the respective actuators in order to effect the control. The maintenance station further receives position and state sensor input from the PWA 20/casing, and the maintenance station 26/support. The PWA 20 and casing preferably include a print-ready sensor that indicates when the PWA 20 is in the operative position, and one or more other sensors for detecting other positions the consolidated PWA 20 may be in. For example the wiping, capping and retracted/sponging positions might all have respective sensors. Furthermore the maintenance station 26 preferably comprises two position sensors, (for the idle and operative positions, respectively), and a plurality of state and position sensors for detecting activation of a vacuum, state of the air intake valves, positions of the capping plate, activation of the wiper motor or sponging motor, etc. Finally triggering of an emergency cut-off switch is preferably (directly or indirectly) communicated to the maintenance controller 122.

In alternative embodiments, the motion of the PWA and/or the motion of the maintenance station may be different. For example the PWA may be tilted, or pivoted in other embodiments to achieve substantially the same objectives in substantially the same manner. In order to maintain a compact web, it is desirable to minimize a vertical distance between the PWAs, particularly when multiple PWAs are used. Tilting the PWAs is incompatible with maintaining this vertical proximity, unless the distance traveled by the PWA is extended. Extending the distance traveled by the PWA is undesirable for many reasons, including cost of control systems and drive systems.

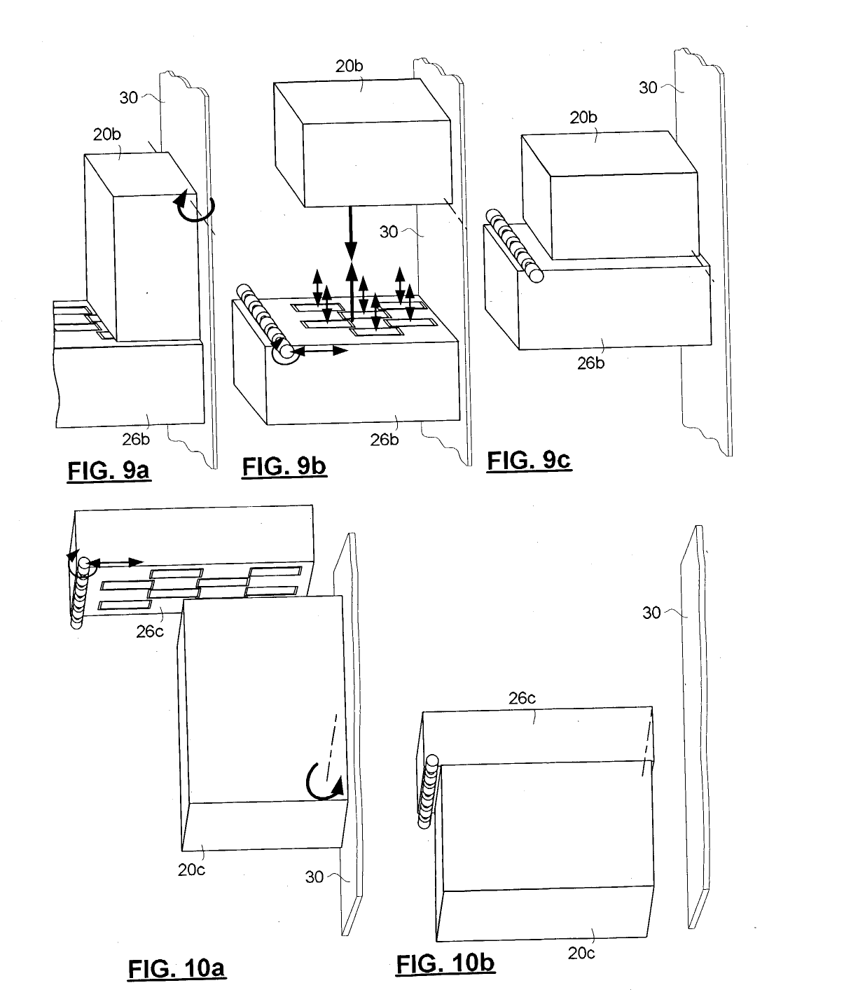

Schematically illustrated in FIGS. 9a, b, c is an embodiment of the present invention wherein the motion of a consolidated PWA 20b involves tilting the PWA 20b from the operative printing position where the nozzles are horizontal (as in FIG. 9a), to a position where the nozzles face downward (as in FIGS. 9b, c). In the operative position, the PWA 20b sits on the maintenance station 26b that faces upwards. The maintenance station 26b comprises a capping module that moves caps of a corresponding capping plate upwards, and a mobile sponging module that slides towards and away from the paper web 30 to wick ink from the face plates of jetting modules (not in view) of the PWA 20b, when the face plates and maintenance station 26b are separated by a predefined distance. Either the maintenance station 26b rises to meet the PWA 20b, or the PWA 20b is further adapted to fall into contact with the maintenance station 26b, so that they can be joined in pressure contact as illustrated in FIG. 9c. Advantageously the force of gravity aids in cleaning of the face plates of the jetting modules in accordance with this embodiment.

FIGS. 10a, b schematically illustrate yet another embodiment of the present invention, wherein a PWA 20c is adapted to pivot 90 degrees from the operative position into a first position. A maintenance station 26c faces horizontally (at right angles to the direction the PWA 20c faces), and so are horizontally aligned once the PWA 20c reaches the first position. The maintenance station 26c then moves in the direction it faces, into pressure contact with jetting modules of the PWA 20c. The maintenance station 26c, like the maintenance station 26b, has the mobile sponging module that transversely crosses the surface of the PWA 20c.

The embodiments of the invention described above are intended to be exemplary only. The scope of the invention is therefore intended to be limited solely by the scope of the appended claims.

I/We claim:

1. A component of an apparatus for printing on a planar printing medium, comprising:
a page-wide array (PWA) of jetting modules comprising
a plurality of ink-jet nozzles, adapted to be moveable between
an operative position in which the face of the PWA is parallel to and proximate to the printing medium and
a maintenance position in which the face of the PWA is not both parallel to and proximate to the printing medium,
a mechanism adapted to accurately support the PWA while in the operative position and in the maintenance position, and while being moved therebetween; and
a maintenance station adapted to engage the face of the PWA while in the maintenance position and not to interfere with printing operations while the PWA is in the operative position,
whereby maintenance operations may be performed on the face of the PWA without requiring the removal of either the PWA or the printing medium from the printing apparatus.

2. A component as claimed in claim 1 wherein the face of the PWA while in the maintenance position is parallel to but retracted from the printing medium.

3. A component as claimed in claim 1 wherein the face of the PWA while in the maintenance position is not parallel to the printing medium.

4. A component as claimed in claim 3 wherein the PWA is pivotally engaged with the support mechanism and the face of the PWA while in the maintenance position is angularly displaced relative to the face of the PWA while in the operative position.

5. A component as claimed in claim 1 wherein the support mechanism is adapted to releasably lock the PWA in the operative position.

6. A component as claimed in claim 1 wherein the support mechanism is adapted to releasably lock the PWA in the maintenance position.

7. A component as claimed in claim 1 wherein the support mechanism comprises sensor means for determining when the PWA is in the operative position.

8. A component as claimed in claim 1 wherein the maintenance station comprises a capping module adapted to apply suction pressure in a chamber about each nozzle and remove fluid disposed thereon.

9. A component as claimed in claim 8, wherein the capping module is adapted to apply suction pressure to the chamber while ink is ejected from the nozzle within the nozzle.

10. A component as claimed in claim 8, wherein the capping module comprises an air inlet means for introducing air into the chamber.

11. A component as claimed in claim 8, wherein the capping module comprises an air outlet means for exhausting air from the chamber.

12. A component as claimed in claim 8, wherein the capping module is adapted to provide an imperfect seal so that external air may enter the chamber about each nozzle when suction pressure is no longer applied and incrementally repressurized thereby.

13. A component as claimed in claim 8, wherein the capping module is adapted to move toward and away from the face of the PWA while in the maintenance position.

14. A component as claimed in claim 1 wherein the maintenance station comprises a wiping module adapted to wipe solvent from the face plates of jetting modules of the PWA.

15. A component as claimed in claim 14, wherein the wiping module comprises a plurality of wipers each adapted to wipe solvent from a respective face plate.

16. A component as claimed in claim 14, wherein the wiping module is adapted to wipe solvent from one face plate without pushing it onto an adjacent face plate.

17. A component as claimed in claim 14, wherein the wiping module is adapted to apply substantially uniform pressure on all face plates.

18. A component as claimed in claim 14 wherein maintenance station is adapted to remove solvent from the wiping module upon completion of the maintenance operation.

19. A component as claimed in claim 1 wherein the maintenance station comprises a sponging module adapted to present absorbent material to the face plates of jetting modules of the PWA, whereby solvent may be wicked away therefrom.

20. A component as claimed in claim 19, wherein the sponging module is adapted to move a roll of absorbent material across the face plate of a jetting module.

21. A component as claimed in claim 19, wherein the sponging module is adapted to engage the face plates while the maintenance station is being withdrawn from engaging the face of the PWA.

22. A component as claimed in claim 19, wherein the maintenance station is adapted to remove solvent from the sponging module upon completion of the maintenance operation.

23. A component as claimed in claim 1 wherein the support mechanism comprises a rail system adapted to accurately maintain the PWA in the operative position and to move the PWA between the operative position and the maintenance position.

24. A component as claimed in claim 1 further comprising a maintenance controller adapted to receive sensor data relating to the position of the PWA and the maintenance station and control operation of the PWA and maintenance station in response thereto.

25. A method of maintaining an apparatus for printing on a planar printing medium, comprising a page-wide array (PWA) of jetting modules comprising a plurality of ink-jet nozzles and a maintenance station, without requiring the removal of either the PWA or the printing medium from the apparatus, comprising the steps of:
moving the PWA from an operative position in which the face of the PWA is parallel to and proximate to the printing medium to a maintenance position in which the face of the PWA is not both parallel to and proximate the printing medium;
positioning the maintenance station so that it engages the face of the PWA while in the maintenance position;
performing maintenance operations on the PWA using the maintenance station;
disengaging the maintenance station to a position where it will not interfere with printing operations while the PWA is in the operative position; and
returning the PWA to the operative position.

26. A method as claimed in claim 25, wherein the step of moving comprises retracting the PWA away from the printing medium in a direction transverse to the plane of the printing medium.

27. A method as claimed in claim 25, wherein the step of moving comprises rotating the PWA away from the printing medium so that the face of the PWA is no longer parallel to the printing medium.

28. A method as claimed in claim 25, wherein the step of performing comprises the steps of:
moving a capping module to engage each nozzle and create a chamber thereabout;
applying solvent within the chamber to remove unwanted materials disposed on the nozzle;
applying suction pressure within the chamber to remove fluid disposed on the nozzle.

29. A method as claimed in claim 28, wherein the step of performing further comprises the step of allowing external air to enter the chamber through an imperfect seal when suction pressure is no longer applied to incrementally repressurize the chamber thereby.

30. A method as claimed in claim 28, wherein the step of applying solvent comprises ejecting ink from the nozzle.

31. A method as claimed in claim 25, wherein the step of performing comprises the steps of:
engaging the face plates of jetting modules of the PWA with respective wipers and
wiping solvent from the face plates of the respective jetting modules using the wipers.

32. A method as claimed in claim 31, further comprising the step of removing solvent from the wipers upon completion of the maintenance operation.

33. A method as claimed in claim 31, wherein the wipers are moved in a circuitous path.

34. A method as claimed in claim 33, wherein the circuitous path causes the wipers to apply substantially uniform pressure on all parts of the respective face plates.

35. A method as claimed in claim 33, wherein the circuitous path prevents the wipers from moving wiped solvent onto adjacent jetting modules.

36. A method as claimed in claim 33, wherein the circuitous path prevents the wipers from contacting obstructions on the face of the PWA.

37. A method as claimed in claim 25, wherein the step of performing comprises the steps of:
applying absorbent material to the face plates of jetting modules of the PWA to wick away any solvent thereon.

38. A method as claimed in claim 37, further comprising the step of removing solvent from the absorbent material upon completion of the maintenance operation.
